(19) United States
(12) Patent Application Publication
(10) Pub. No.: US 2018/0151082 A1
(43) Pub. Date: May 31, 2018

(54) TRAINING MANAGEMENT SYSTEM

(71) Applicant: Duggan & Associates, Inc., North Kingstown, RI (US)

(72) Inventor: Kevin J. Duggan, North Kingstown, RI (US)

(73) Assignee: Duggan & Associates, Inc., North Kingstown, RI (US)

(21) Appl. No.: 15/824,426

(22) Filed: Nov. 28, 2017

Related U.S. Application Data
(60) Provisional application No. 62/426,848, filed on Nov. 28, 2016.

(51) Int. Cl. G09B 5/02; G06F 3/0481; G06F 3/0482; G06F 3/0488; G09B 7/10

(52) U.S. Cl. CPC G09B 5/02; G06F 3/04817; G09B 19/003; G06F 3/0488; G09B 7/10; G06F 3/0482

(57) ABSTRACT

A computer-implemented method for providing a presentation, for use in a training course, includes, receiving a course having course content with a plurality of slides having predefined instructor content and mandatory points; displaying the slides in a slide display area; selectively displaying instructor content for a selected slide from the plurality of slides in a section display area; and indicating whether a selected slide has a mandatory point. The method may include the use of a timer for mandatory points with freezing of navigation between slides for the duration of the timer.

### CROSS-REFERENCE TO RELATED APPLICATION

This patent document claims priority to earlier filed U.S. Provisional Application No. 62/426,848, filed on Nov. 28, 2016, the entire contents of which are incorporated herein by reference.

### BACKGROUND

### 1. Technical Field

The present disclosure relates generally to training systems and more particularly to a training management system with guided prompts that ensures standardized training from instructors and fosters improved student engagement.

### 2. Background of the Related Art

Training seminars and other information seminars where a presenter instructs a group of students using a combination of slides, white board, props and other materials are a primary tool for companies and organizations to pass along critical company policies, procedures, legal information and safety standards. For instance, some training seminars often pass along critical legal and safety requirements which reduce liabilities, improve worker safety and keep the companies in compliance with government mandates. It is critical that this information be passed along accurately and consistently over multiple presentations that may be completed by different presenters. However, ensuring that the instructor provides consistent delivery of the instructional material to the students is challenging. Accordingly, there is a perceived need in the industry for a method and system of promoting consistent delivery and presentation of instructional material to students that ensures that all students receive comprehensive and consistent instructions, but also promotes increased engagement of student audience as well.

### SUMMARY

The present system provides an electronic presentation system and application that captures and gains student attention by using dynamic engagement techniques that consistently prompt the instructor when and how to involve students during the course of a presentation. The system further promotes consistent delivery of the instructional material from instructors to students.

Accordingly, among the objects of the applications are:

For Instructors:
Providing the ability to know what to say, draw and ask for each slide.
Providing prompts and key information to know what slides need to be taught verbatim for legal or regulatory purposes.
Providing the ability to select among different presentation modes based on level of experience—expert versus instructor.

For Training Managers:
Providing instantaneous updates to all instructors in real time.
Training new instructors and employees and get them up to expert level quickly.
Having confidence that content is delivered consistently worldwide.

For Course Developers:
Providing a universal framework for developing and assuring engagement in all training courses.
Quickly analyzing instruction effectiveness with metrics that measure the utilization of engagement points.
Ensuring that instructors are delivering knowledge as it was intended to be delivered.

For Corporate Executives:
Ensuring the money invested in training is used effectively by providing a knowledge delivery system.
Eliminating paper manuals that are costly to create and maintain.
Educating trainers faster, dramatically lowering trainer costs.

### BRIEF DESCRIPTION OF THE DRAWINGS

These and other features, aspects, and advantages of the present invention will become better understood with reference to the following description, appended claims, and accompanying drawings where:

FIG. 1A shows an illustration of the overall system for distributing course content in a training management system;

FIG. 1B shows an illustration of a device that may be used to provide and/or distribute content in a training management system;

FIG. 2 shows a screenshot of a client application showing a list of available courses to use;

FIG. 3 shows another screenshot of a client application showing a list of available courses to use and course synchronization features;

FIG. 4 shows another screenshot of a client application showing a list of available courses to use and course filter and sorting features;

FIG. 5 shows an instructor screen of a selected course of a client application of the training management system with a left icon area visible and a right icon area hidden;

FIG. 6 shows another instructor screen of a selected course of a client application of the training management system with a left icon area and a right icon area visible;

FIG. 7 shows an exemplary screenshot of a slide key points feature enabled course of a client application of the training management system;

FIG. 8 shows an exemplary screenshot of a slide flip charts/whiteboards feature enabled course of a client application of the training management system;

FIG. 9 shows an exemplary screenshot of a slide engagement directives feature enabled course of a client application of the training management system;

FIG. 10 shows an exemplary screenshot of a slide images feature enabled with a first image selected of a course of a client application of the training management system;

FIG. 11 shows an exemplary screenshot of a slide images feature enabled with a second image selected of a course of a client application of the training management system;

FIG. 12 shows an exemplary screenshot of a slide mentor notes feature enabled of a course of a client application of the training management system;

FIG. 13 shows an exemplary screenshot of a slide quiz question feature enabled of a course of a client application of the training management system;

FIG. 14 shows an exemplary screenshot of a slide reference material feature enabled of a course of a client application of the training management system;

FIG. 15 shows an exemplary screenshot of a slide personalized instructor notes feature enabled of a course of a client application of the training management system, illustrating a pop-up keyboard for entering notes;

FIG. 16 shows an exemplary screenshot of a function mode enabled of a client application for a training management system, showing the available slides in a course.

FIG. 17 shows an exemplary screenshot of a function mode enabled of a client application for a training management system, showing the available slides in a course and slide filter and sorting features;

FIG. 18 shows an exemplary screenshot of a function mode enabled of a client application for a training management system, showing a display area and left and right icon areas of a selected slide;

FIG. 19 shows an exemplary screenshot of a function mode enabled of a client application for a training management system, showing a display area and left and right icon areas of a selected slide, with a keyboard entry area of editing slide notes, annotations and content;

FIG. 20 shows an exemplary screenshot of an expert mode enabled of a client application for a training management system, showing slides displayed sequentially in a display area where a first slide is shown selected;

FIG. 21 shows an exemplary screenshot of an expert mode enabled of a client application for a training management system, showing slides displayed sequentially in a display area where a second slide is shown selected;

FIG. 22 shows an exemplary screenshot of a mandatory points feature of a client application for a training management system while in instructor mode;

FIG. 23 shows an exemplary screenshot of a mandatory points feature with a timer enabled of a client application for a training management system while in instructor mode;

FIG. 24 shows an exemplary screenshot of navigating to a mandatory points summary screen through a menu of a client application for a training management system while in instructor mode;

FIG. 25 shows an exemplary screenshot of a summary of completed mandatory points of a client application for a training management system;

FIG. 26 shows an exemplary screenshot of a draft test summary email of completed mandatory points of a client application for a training management system;

FIG. 27 shows an exemplary screenshot of filtering slides by mandatory points feature of an application for a training management system while in function mode;

FIG. 28 shows an exemplary screenshot of a mandatory points feature of an application for a training management system while in expert mode;

FIG. 29 shows an exemplary screenshot of activating a timer of a mandatory points feature of an application for a training management system while in expert mode; and

FIG. 30 shows an exemplary flowchart of a computer-implemented method of a training management system.

### DESCRIPTION OF THE PREFERRED EMBODIMENT

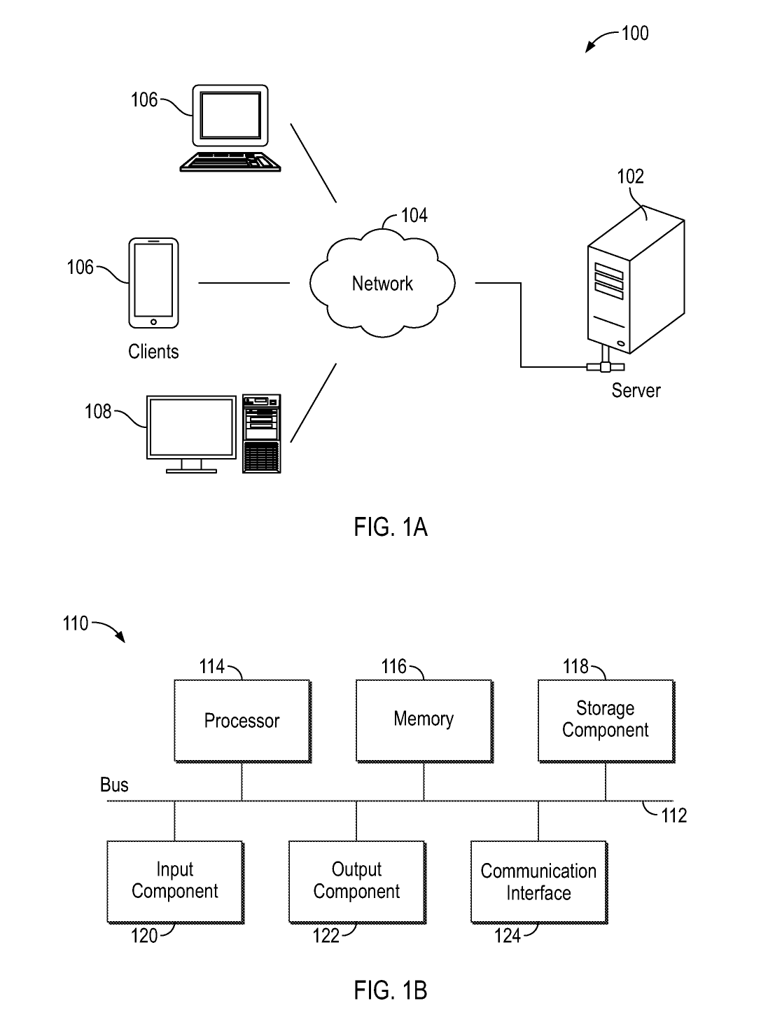

Referring to FIG. 1A, the overall system is shown generally at 100 and includes one or more servers 102 connected via a network 104, such as the internet, to one or more client devices 106, 108 that are used by instructors and course content creators. In use, course content creators work to create course presentations with associated instructor prompts. The course materials, including instructor prompts and supplemental presentation materials are uploaded to a main server-side software application to create a “course” 202 that is accessible to training staff. Once these “courses” 202 are created, they can be delivered to the instructor client devices 106, 108 for presentation to a class. The course presentation themselves may be slide presentations, such as Microsoft Power Point presentations, or images, such as JPEG or PNG files.

The instructor prompts, provided through the instructor screen 204 of the client application 200, described in more detail below, provides guided prompts to the instructor to ensure consistent delivery of content of the course 202 to the students of the course 202. Prepackaged courses may be purchased through the system or custom content may be prepared and provided by a course sponsor, such as a business's safety office, for work safety video, or human resources department, for personnel policies, for example. It is noted here that the present instructor's system is used in conjunction with a traditional PowerPoint presentation or other presentational materials that are provided to the participants. The present system provides the instructor the ability to step through the presentation materials and have access to the additional annotation materials, notes, prompts etc. so that each instructor generally has consistent presentation delivery and style.

Network 104 may include one or more wired and/or wireless networks associated with a user. For example, network 104 may include a local area network (LAN), a wide area network (WAN), a private network, an intranet, a cellular network, a public land mobile network (PLMN), a metropolitan area network (MAN), a telephone network (e.g., the Public Switched Telephone Network (PSTN)), an ad hoc network, the Internet, a fiber optic-based network, a cloud computing network, or the like, and/or a combination of these or other types of networks.

The number and arrangement of devices and networks shown in FIG. 1A are provided as an example. In practice, there may be additional devices and/or networks, fewer devices and/or networks, different devices and/or networks, or differently arranged devices and/or networks than those shown in FIG. 1A. Furthermore, two or more devices shown in FIG. 1A may be implemented within a single device, or a single device shown in FIG. 1A may be implemented as multiple, distributed devices.

FIG. 1B is a diagram of example components of a device 110. Device 110 may correspond to client device 106, 108 and server 102. In some implementations, client device 106, 108 and server 102 may include one or more devices 110 and/or one or more components of device 110. As shown in FIG. 1B, device 110 may include a bus 112, a processor 114, a memory 116, a storage component 118, an input component 120, an output component 122, and a communication interface 124.

Bus 112 may include a component that permits communication among the components of device 110. Processor 112 is implemented in hardware, firmware, or a combination of hardware and software. Processor 114 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 116 may include a random access memory (RAM), a read only memory (ROM), and/or another type of dynamic or static storage device (e.g., a flash memory, a magnetic memory, an optical memory, etc.) that stores information and/or instructions for use by processor 114.

Storage component 118 may store information and/or software related to the operation and use of device 110. For example, storage component 118 may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

Input component 120 may include a component that permits device 110 to receive information, such as via user input (e.g., a touch screen display, a keyboard, a keypad, a mouse, a button, a switch, a microphone, etc.). Additionally, or alternatively, input component 120 may include a sensor for sensing information (e.g., a global positioning system (GPS) component, an accelerometer, a gyroscope, an actuator, etc.). Output component 122 may include a component that provides output information from device 110 (e.g., a display, a speaker, one or more light-emitting diodes (LEDs), etc.).

Communication interface 124 may include a transceiver-like component (e.g., a transceiver, a separate receiver and transmitter, etc.) that enables device 110 to communicate with other devices, such as via a wired connection, a wireless connection, or a combination of wired and wireless connections. Communication interface 124 may permit device 110 to receive information from another device and/or provide information to another device. For example, communication interface 124 may include an Ethernet interface, an optical interface, a coaxial interface, an infrared interface, a radio frequency (RF) interface, a universal serial bus (USB) interface, a Wi-Fi interface, a cellular network interface, or the like.

Device 110 may perform one or more processes described herein. Device 110 may perform these processes in response to processor 114 executing software instructions stored by a computer-readable medium, such as memory 116 and/or storage component 118. A computer-readable medium is defined herein as a non-transitory memory device. A memory device includes memory space within a single physical storage device or memory space spread across multiple physical storage devices.

Software instructions may be read into memory 116 and/or storage component 118 from another computer-readable medium or from another device via communication interface 124. When executed, software instructions stored in memory 116 and/or storage component 118 may cause processor 114 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 1B are provided as an example. In practice, device 110 may include additional components, fewer components, different components, or differently arranged components than those shown in FIG. 1B. Additionally, or alternatively, a set of components (e.g., one or more components) of device 110 may perform one or more functions described as being performed by another set of components of device 110.

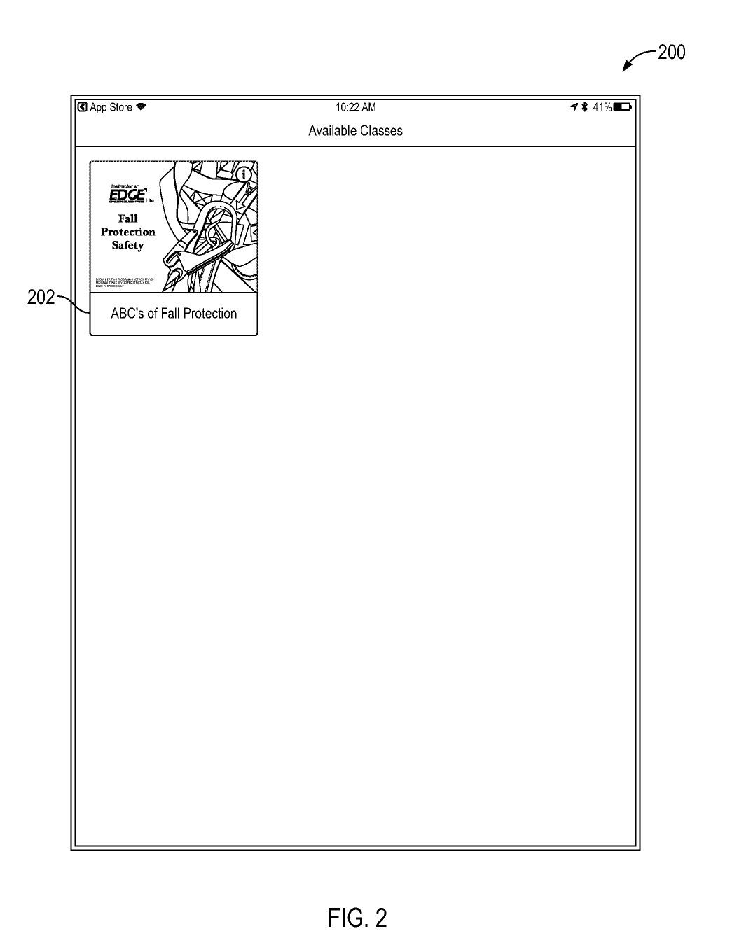

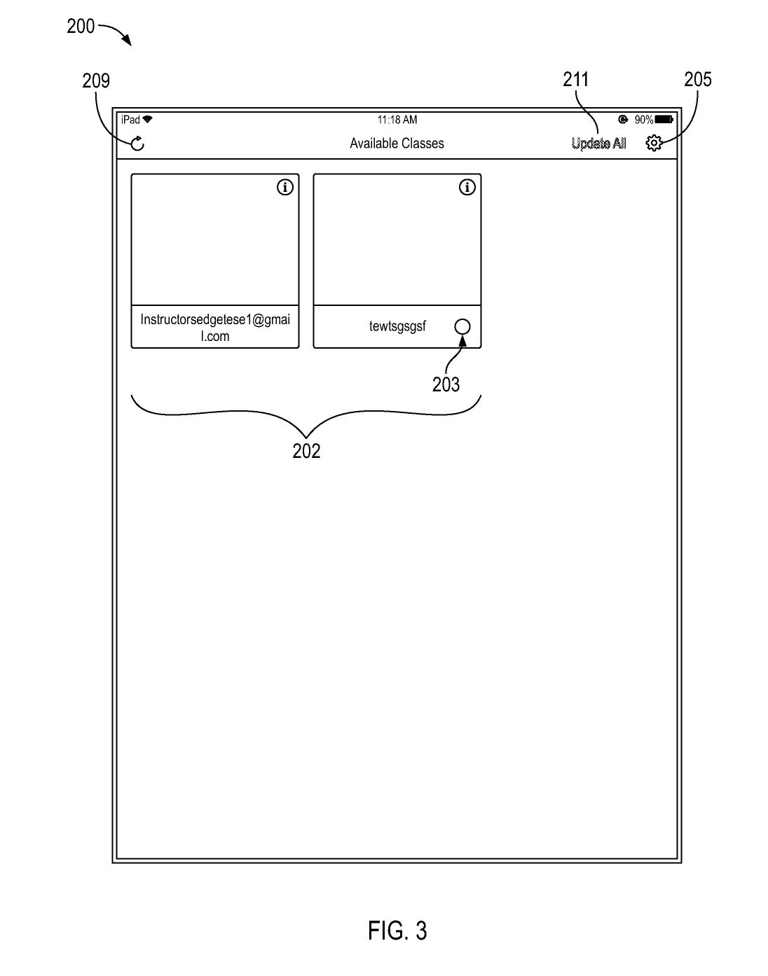

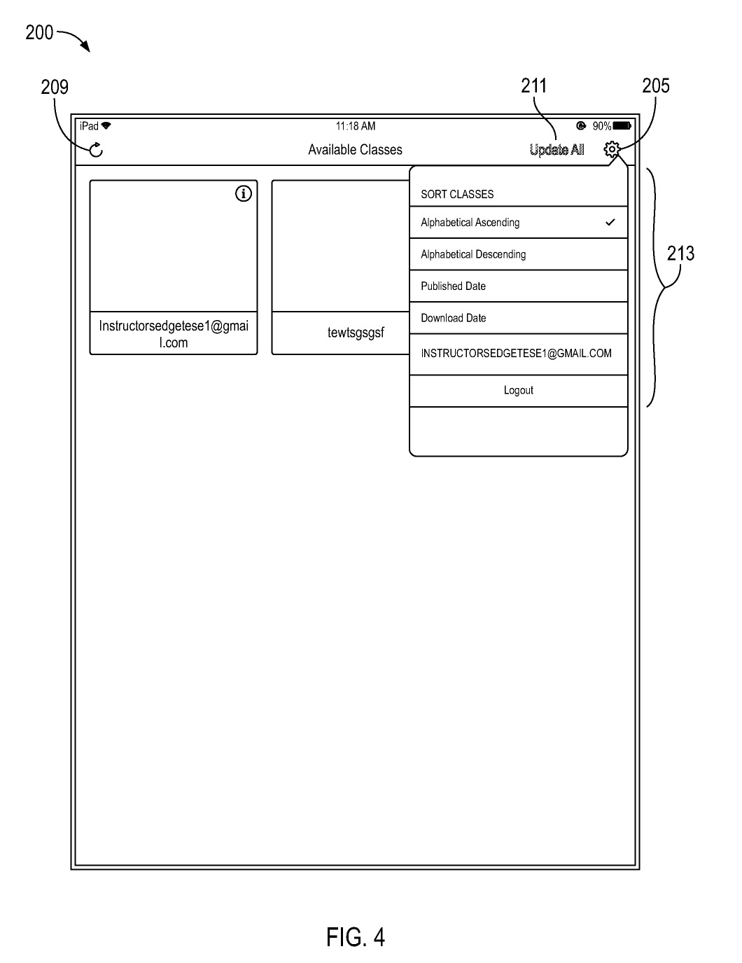

Referring to FIG. 2-4, screenshot of a client application 200 showing a list of available courses 202 is shown. The courses 202 may be organized in tiles where the instructor may select the desired course through the input device, such as a touch screen, of the client device 106. As shown in FIG. 3, multiple courses 202 may be listed. In the upper left of FIG. 3, the system provides for a synchronization of course listings 202 available from the server 102 via a synchronization icon 209 for a selected course listing 202. When activated, this will download any information newly added to a course from the server 102. In the bottom right of each “course” tile, the system further provides an “update indicator” (red dot 203) which tells the instructor that the course has updated content available. Finally, in the upper right an “update all” icon 211 provides for synchronization and update of all course subscriptions. Turning quickly to FIG. 4, the settings icon (gear 205) allows the user to sort multiple course listings according to various filters 213, such as alphabetical or by date.

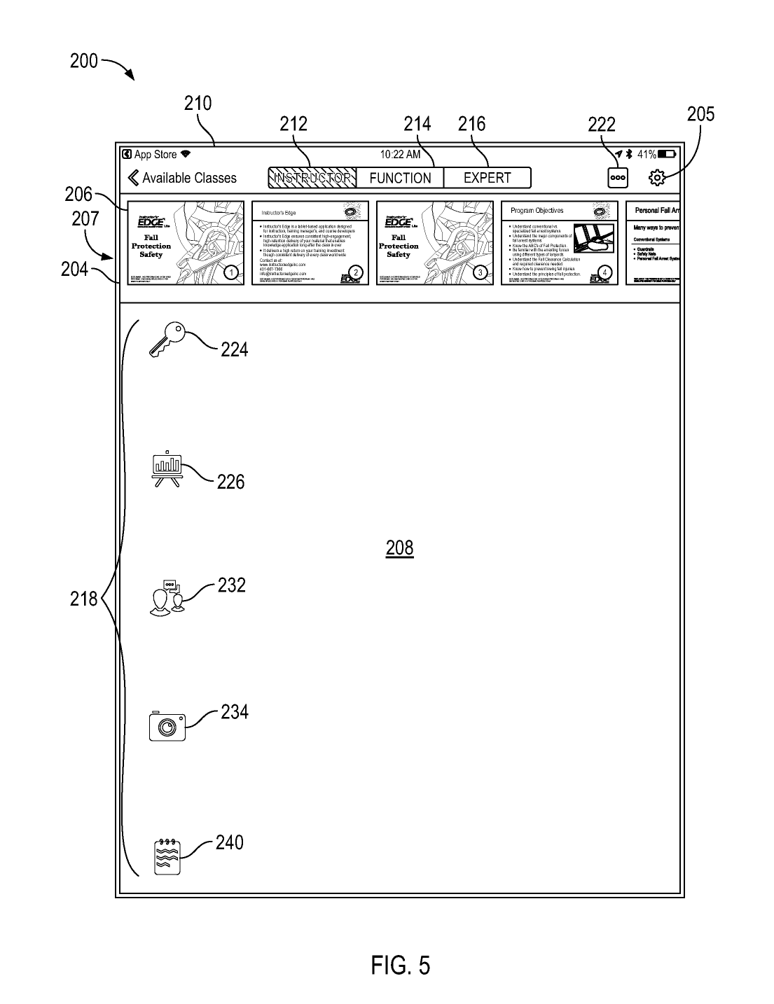

Referring to FIG. 5, upon selecting a desired course 202, the instructor is brought initially to the instructor screen 204, where the instructor may view the slides 206 in a slide display area 207 of the presentation and any associated slide key points, flip charts/whiteboards, engagement directives, mentor notes, memory triggering images, personalized instructor notes section, quiz questions, reference material, systematic tracking of mandatory information in a section display area 208 via icons. The instructor may scroll through the entire selection of slides in the slide display area 207 in the course and choose any slide to view in the section display area.

The menu bar 210 at the top of the screen 204 permits the instructor to select from the instructor mode 212, function mode 214, and expert mode 216, which will be further described below. Essentially these modes organize the information of the course 202 in a manner for the skill-level of the instructor and to aid the instructor in preparation for instructing the course 202.

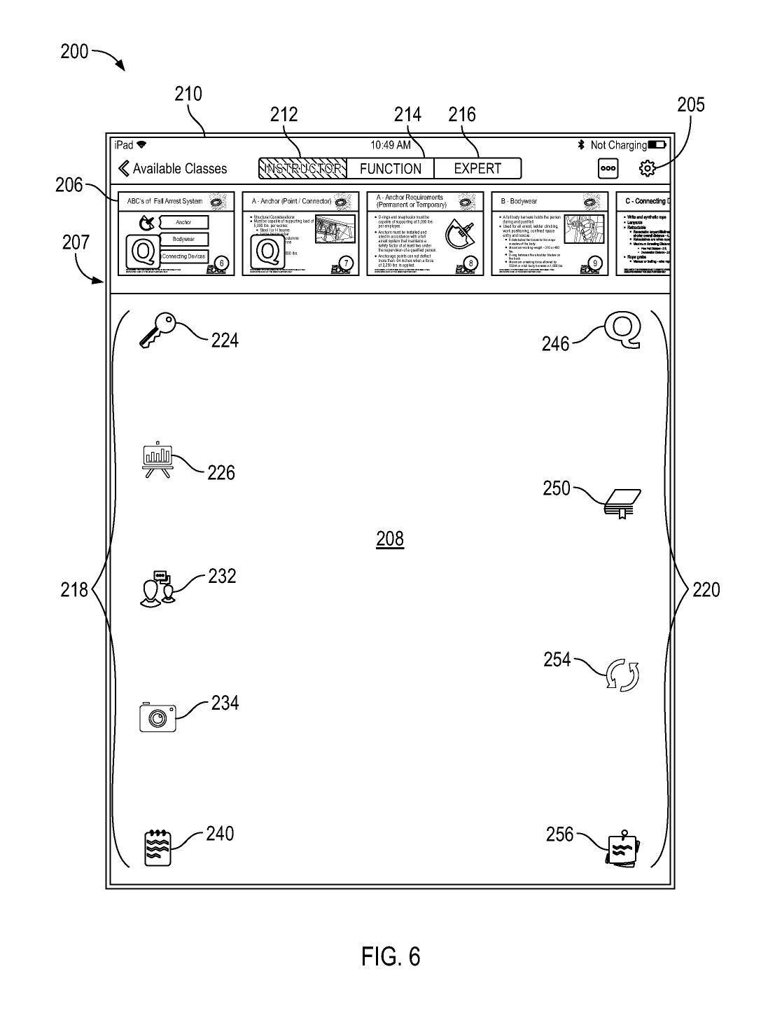

Referring to FIGS. 5 and 6, the main viewing area includes a left icon area 218 and section display 208. A right icon area 220 may be hidden or displayed by toggling the display control 222. Icons in the left icon area 218 and right icon 220 area are greyed-out if no pre-defined content is available, or solid black, indicating predefined content is available. When an icon in the right icon area 220 or left icon area 218 is selected, the icon will change color, such as to blue, to indicate that it is the currently selected icon.

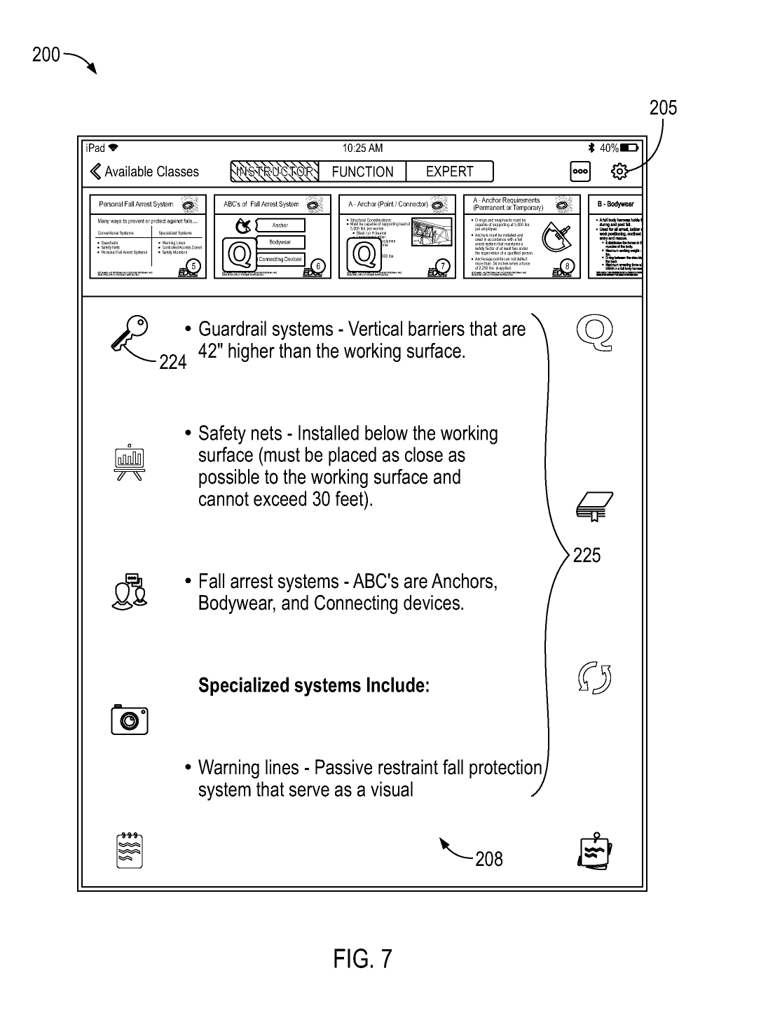

Referring to FIG. 7, a slide “key points” icon 224, when selected, displays key talking points 225 about the selected slide in the display area 208. The display area 208 is scrollable in order to view all the key talking points.

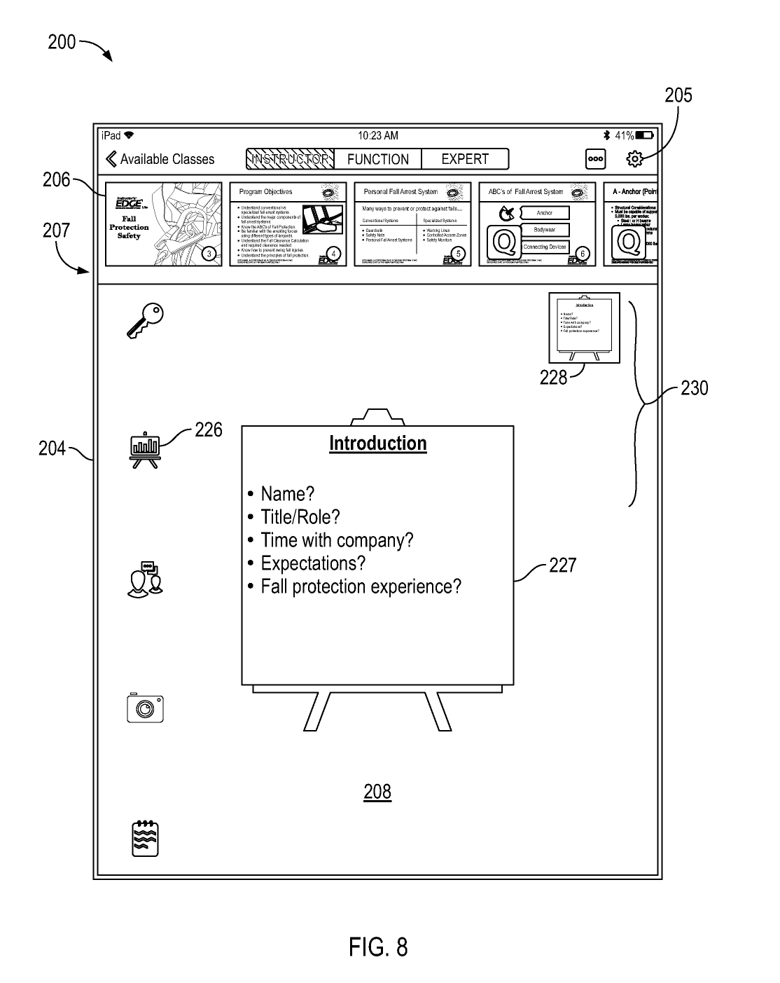

Referring to FIG. 8, a flip charts/whiteboards icon 226, when selected, displays information 227 in the display area 208 that the instructor should display on flip charts and/or write on a white board as part of the presentation. Thumbnails 228 of other selectable information are provided in a thumbnail section 230 adjacent to the display area 208. Images may be further zoomed, rotated and dragged.

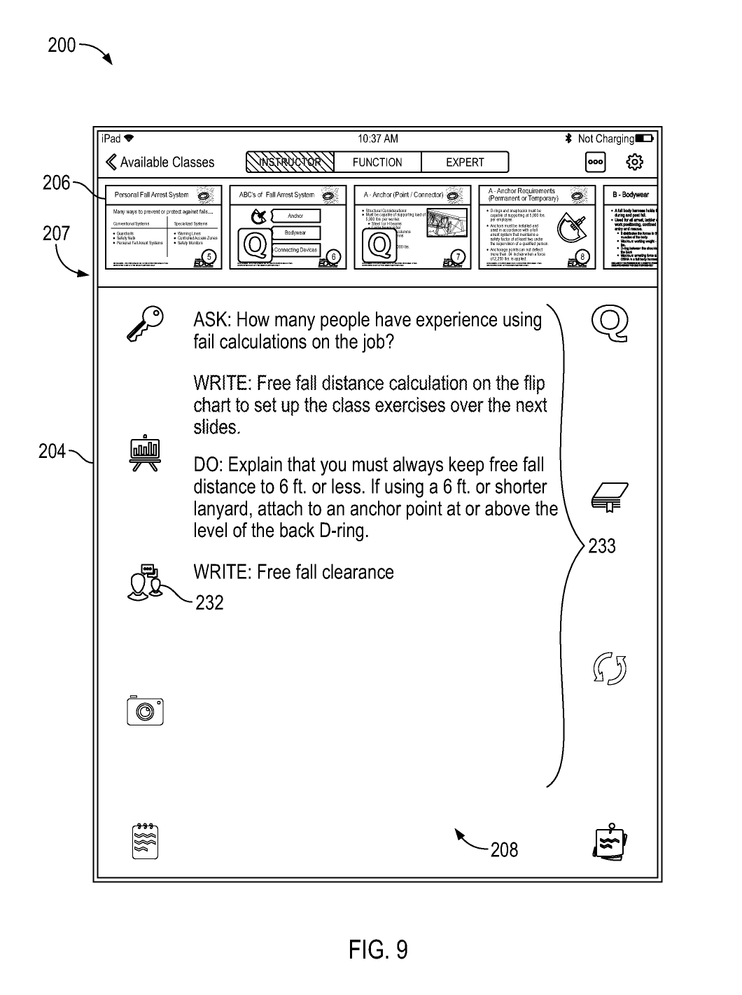

Referring to FIG. 9, an engagement directives icon 232, when selected, provides directives 233 to prompt the instructor to take certain actions such as “ask” the students a question, “write” certain information on the white board or flip chart, and/or “do” some other action, such as explain the material of the slide. These directives are displayed in the display area 208.

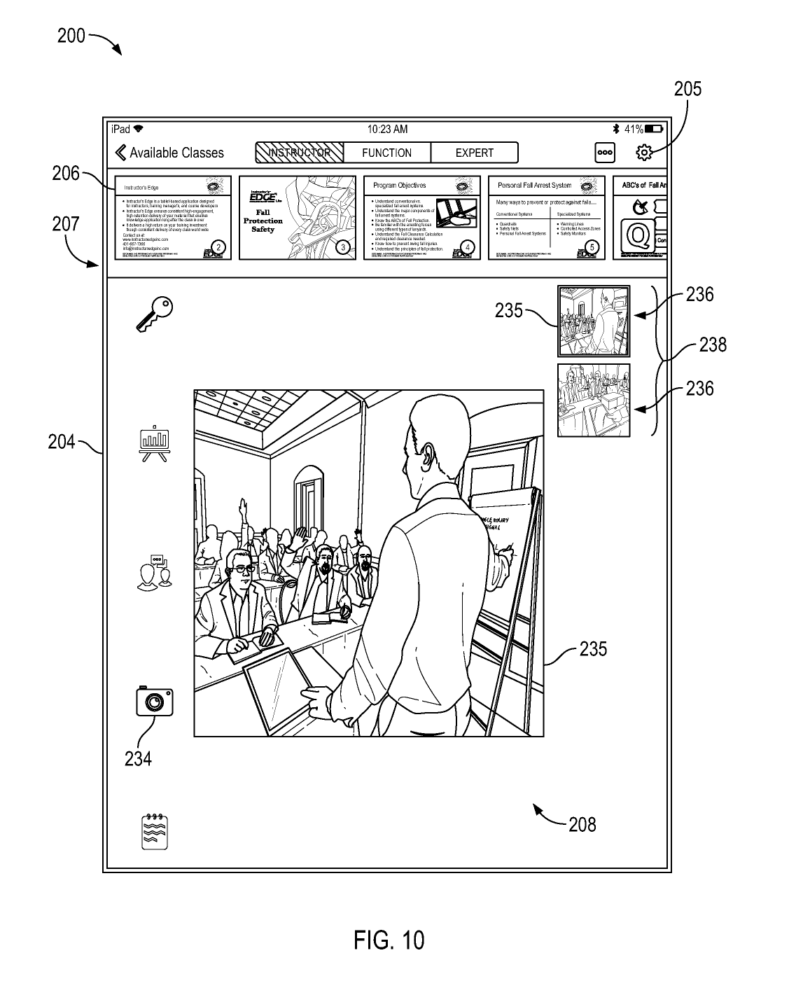

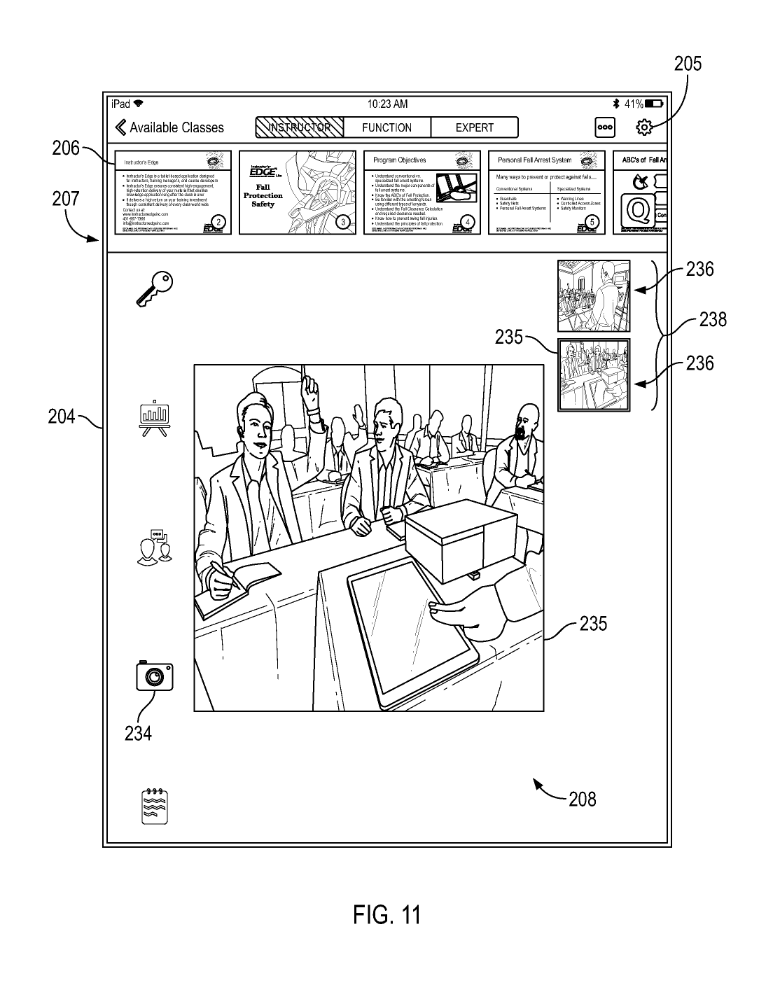

Referring to FIGS. 10 and 11, an images icon 234, when displayed, provides a selection of memory triggering images to aid or otherwise prompt the instructor about actions they should take, such as pointing at material displayed on a flip chart or written on the white board, or solicit student questions, or tell a story, for instance. The images section displays a selected image 235 in the display area 208. Thumbnails 236 of other selectable images are provided in a thumbnail section 238 adjacent to the display area 208. Images may be further zoomed, rotated and dragged.

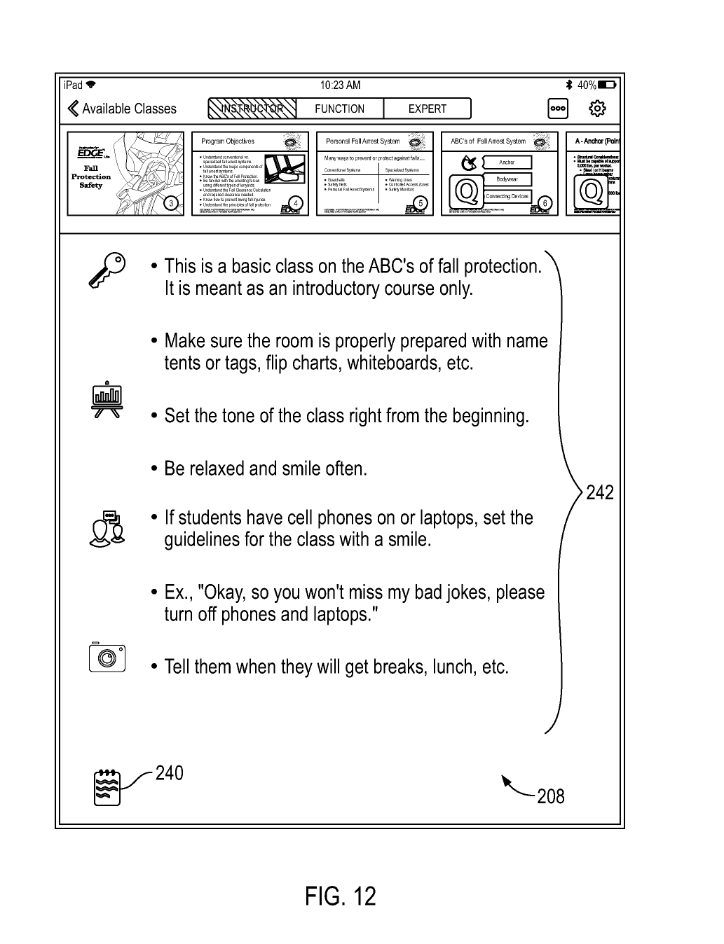

Referring to FIG. 12, a mentor notes icon 240, when selected, displays notes 242 in the display area 208 to the instructor from the instructor's mentor about how to teach the content of the course 202 to the students and other helpful reminders, such as where to find the bathrooms, to instruct the students to disable audible alerts on their phones, and when there will be a break, among others.

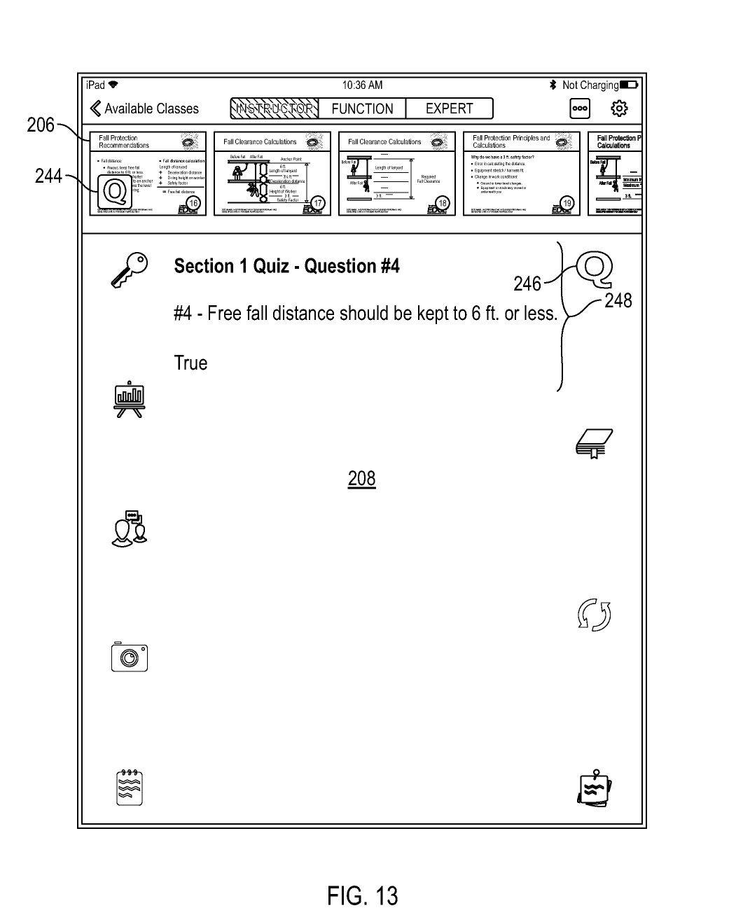

Referring to FIG. 13, if a slide 206 has a quiz question associated with it, the slide 206 will have a quiz indication 244, such as a “Q” superimposed on the slide 206. A quiz question icon 246, when selected, displays a quiz question 248 in the display area 208, to ask the students. The answer is provided adjacent to the question 248 for the instructor. Touching the quiz indication 244 also displays a quiz question 248 in the display area 208. This has the same functionality as pressing 246.

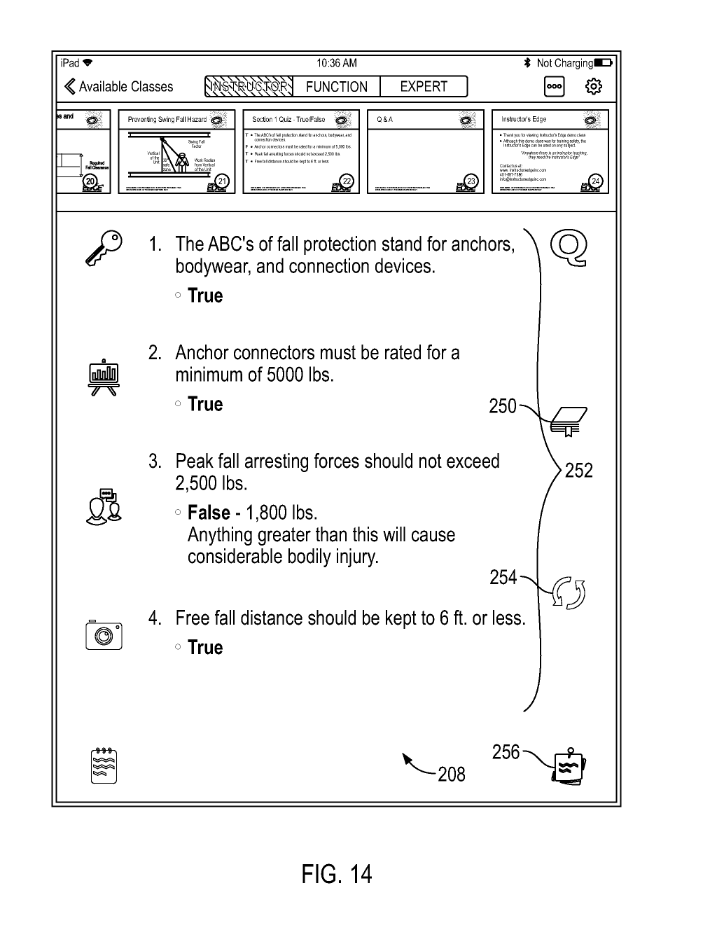

Referring to FIG. 14, a reference material icon 250, when selected, provides additional materials 252 in the display area 208 pertinent to the slide 206 and/or course 202 that the instructor may refer to during instruction.

An updates icon 254 (best seen in FIG. 6), when selected, updated information, either about a slide, recent real-world events, etc. can be loaded. As the instructor navigates through the course and reaches a particular slide where the updates icon 254 is colored black to indicate content is present, the instructor knows additional content is available and can select the updates icon 254 to see what new information is available.

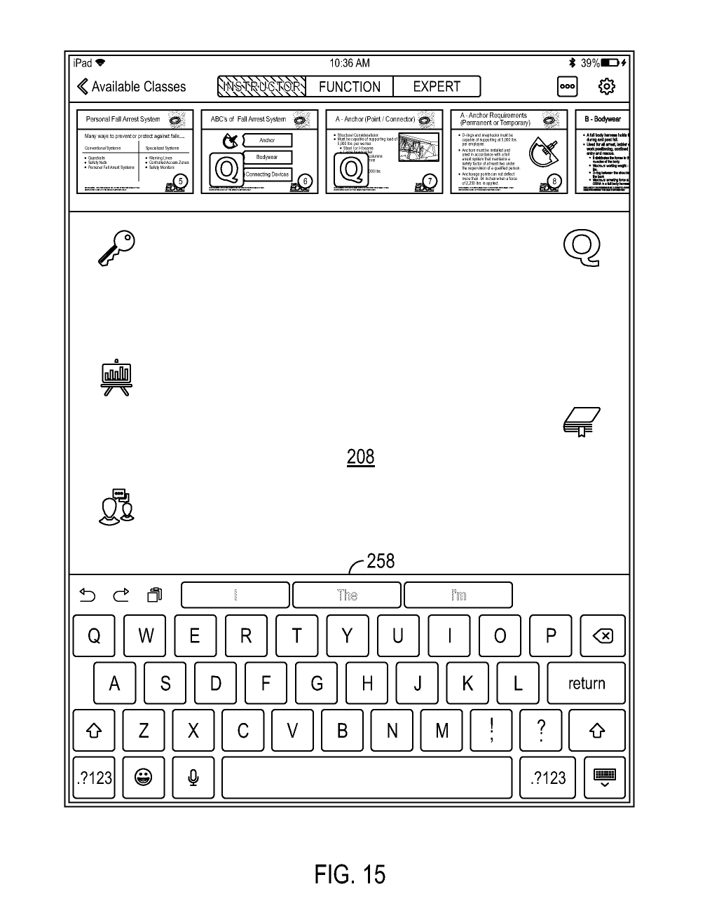

Referring to FIGS. 6 and 14-15, a personalized instructor notes icon 256, when selected, allows the instructor to enter and store their own personal notes for each slide 206 and/or course 202. Activation of a soft keyboard 258 for touch enabled devices is provided for entry of personalized notes. Personalized notes remain on the instructor's device 106 and are not retrieved from or stored on the server 102.

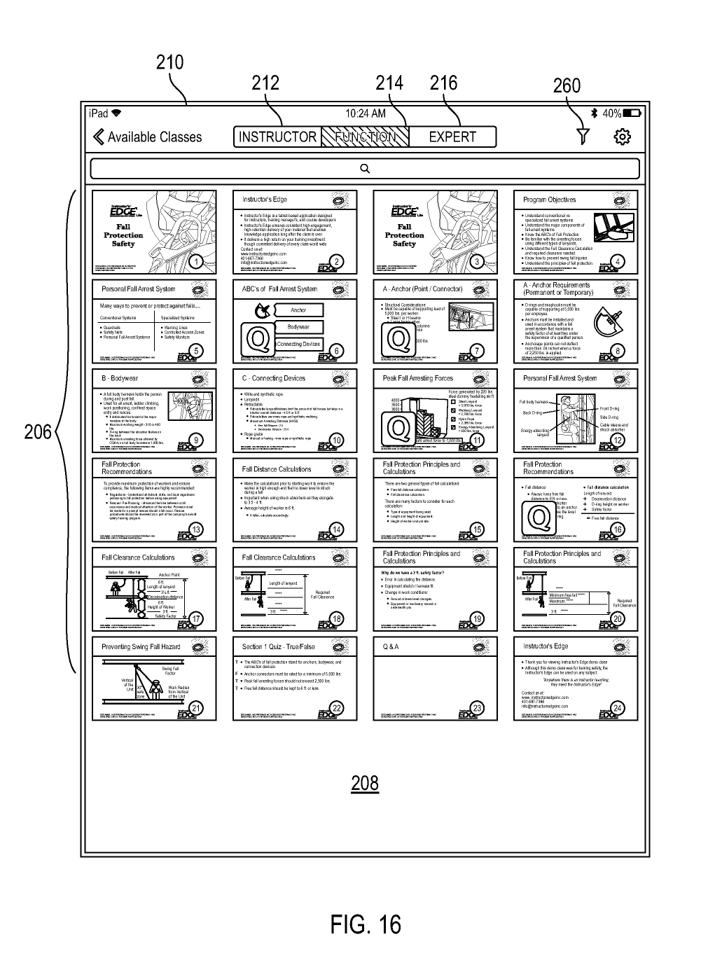

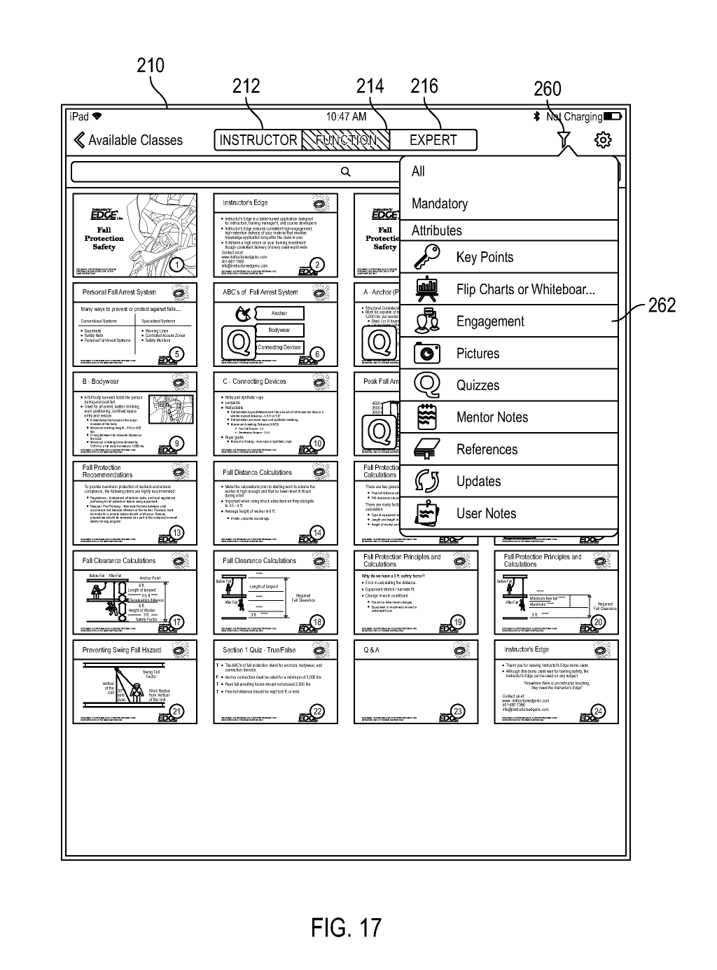

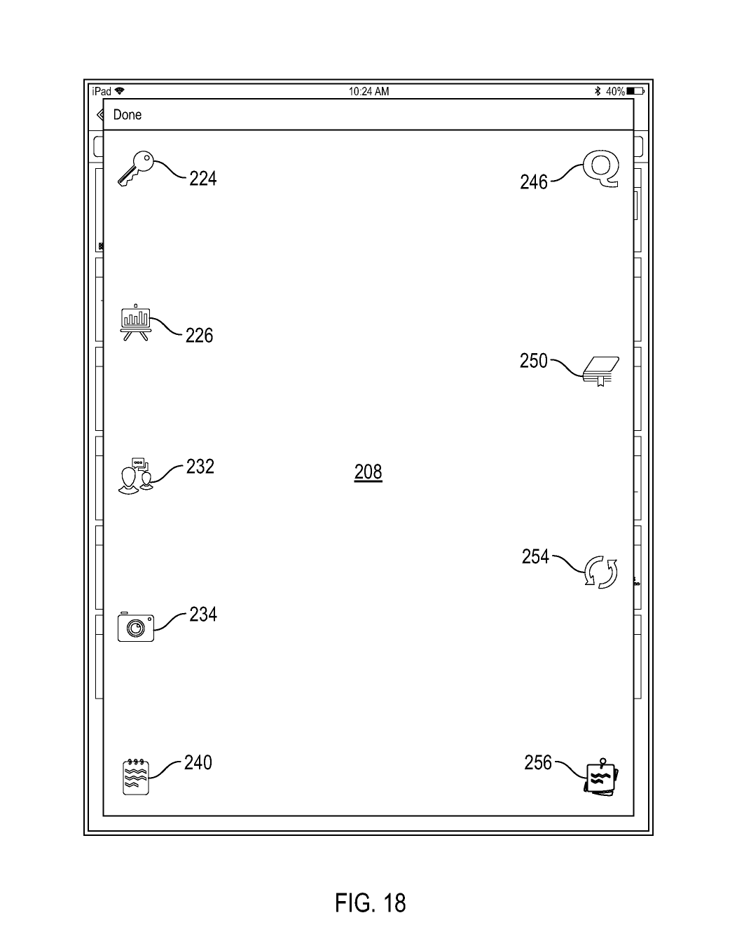

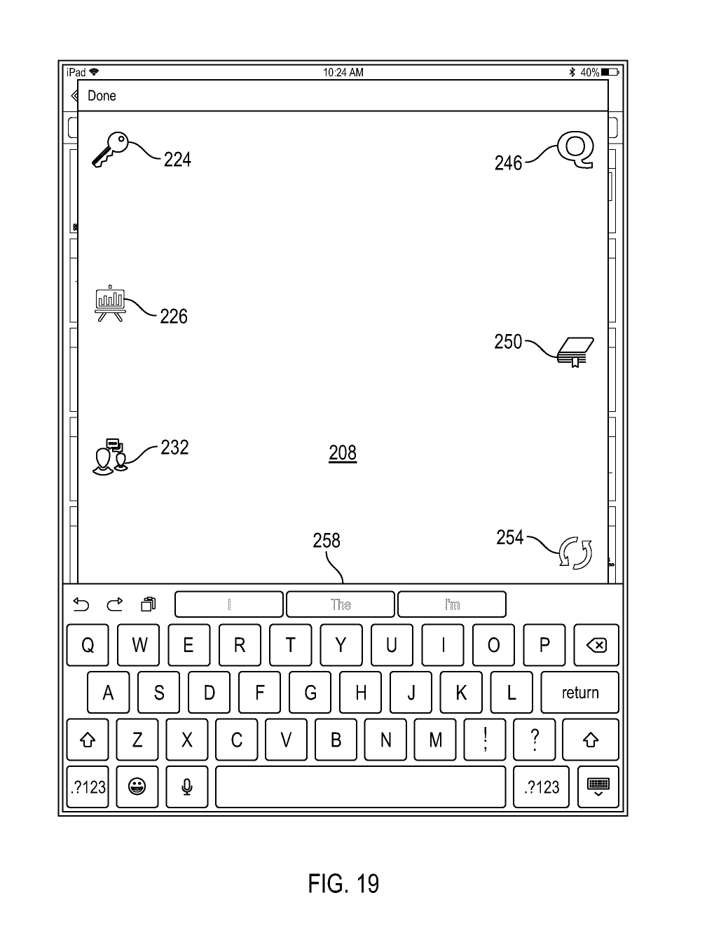

Referring to FIGS. 16-19, in function mode 214, the slides 206 of the course 202 are displayed in tiles of the display area 208. Using the filter icon 260, the instructor may sort and filter the available slides in the course base on selectable attributes 262, such as whether a slide has quiz questions or whether a slide has associated actions or images, for instance (best seen in FIG. 17). In function mode 214, all the same icons 224, 226, 232, 234, 240, 246, 250, 254, 256 and associated sections of information are available to the instructor. The instructor may even enter personalized notes in function mode 214. Function mode can also be used during material preparation to give the instructor information on how much or how little certain slides or areas of the presentation are annotated. The ability to see the annotations across the entire presentation provides critical feedback to ensure that certain sections do not become overemphasized or boring and/or to ensure that certain sections are not forgotten. Accordingly, the function mode 214 is critical in aiding the instructor in preparing for a course 202 that will be taught later, or in editing existing materials or in the preparation of materials for a course that has not been completed. In addition to icons 224, 226, 232, 234, 240, 246, 250, 254, 256, one can also sort by slides that contain icons marked as mandatory.

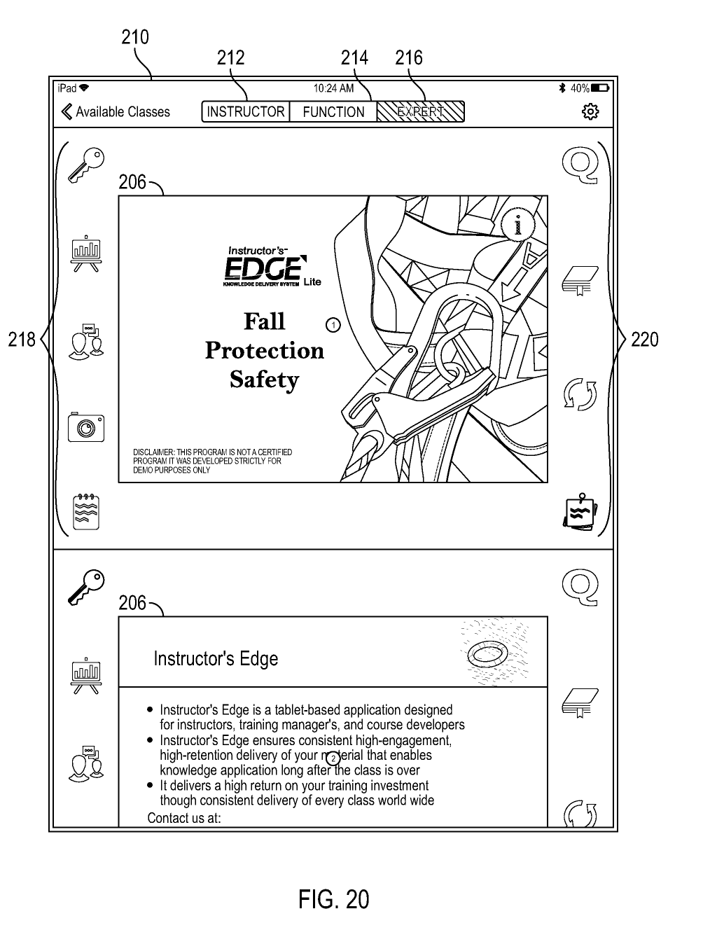

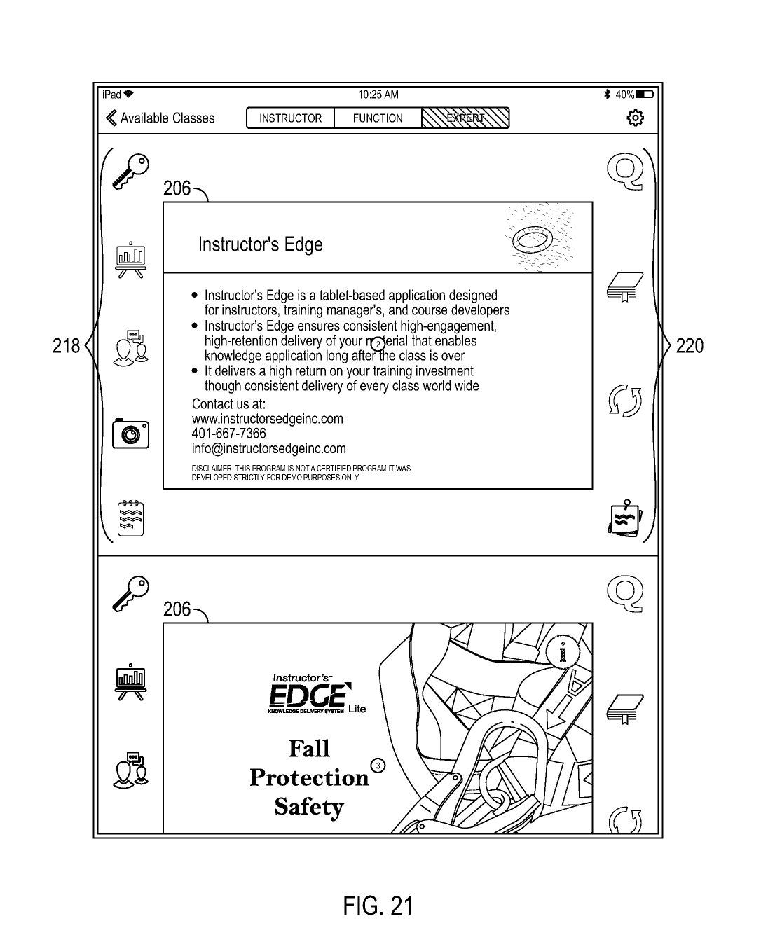

Referring to FIGS. 20 and 21, in expert mode 216, the slides 206 of the course 202 are the focus with left and right icon areas 218, 220 displayed adjacent to each slide 206, where the instructor may access the aforementioned icons 224, 226, 232, 234, 240, 246, 250, 254, 256 and their associated functionality. In expert mode 216, experienced instructors may focus on the slides 206 and course material, and do not necessarily need the prompts and memory triggers that less-experienced instructors need to ensure uniform course content delivery.

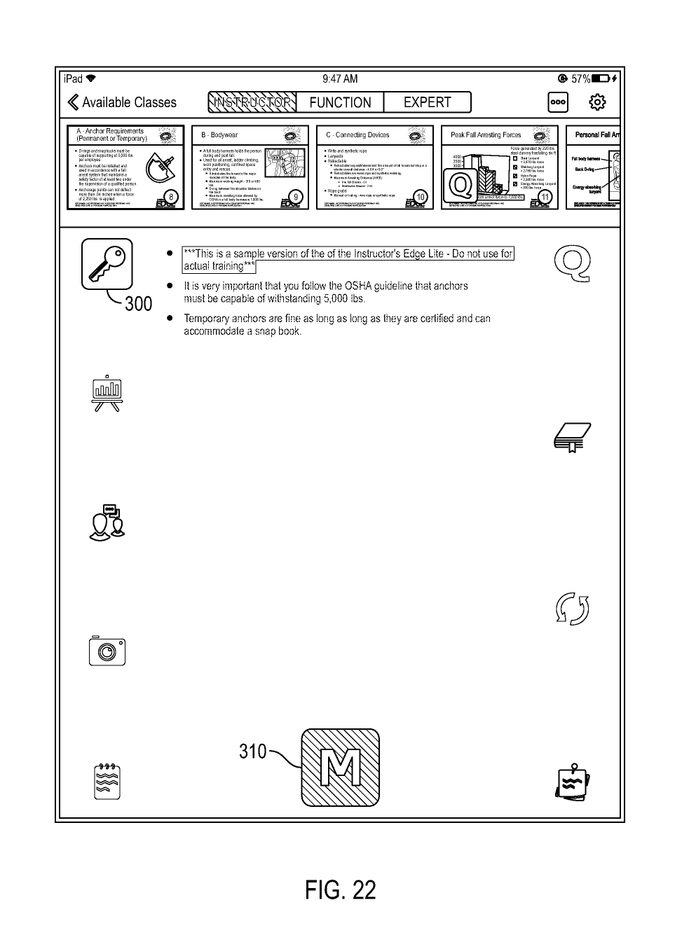

Referring now to FIGS. 22-28, exemplary screenshots of a mandatory points feature of an application for a training management system while in instructor mode are shown generally. In FIG. 20, an icon 300 may be indicated as a mandatory point that the instructor must cover during the training class. The indication may be in the form of a red box around the icon. Further, indication may take the form of a red M 310 to appear at the bottom of the display area. The indication may be animated, such as causing the indication to bounce from side-to-side, to draw the instructor's attention to it.

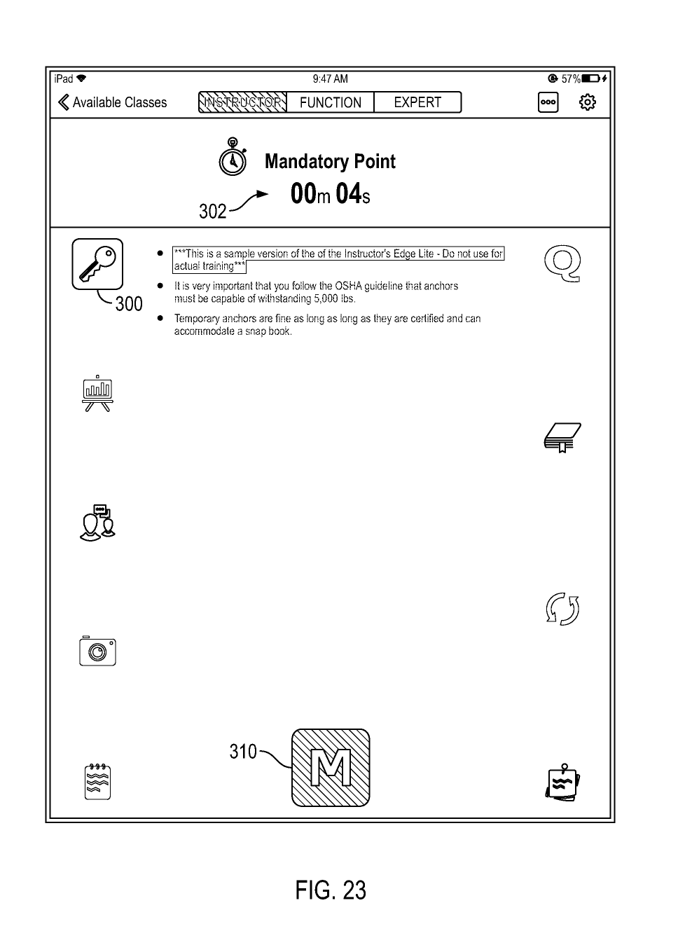

In FIG. 23, selecting the indication starts a stopwatch timer 302. The time continues to count until the indication is selected again. Navigation is also frozen between slides at this time. Selecting the indication again stops the stopwatch timer and marks the indication as complete. For instance, the red M may be changed to a green M. The box 300 around the “key points” icon may also be turned green as well. Navigation to other slides in the course is re-enabled.

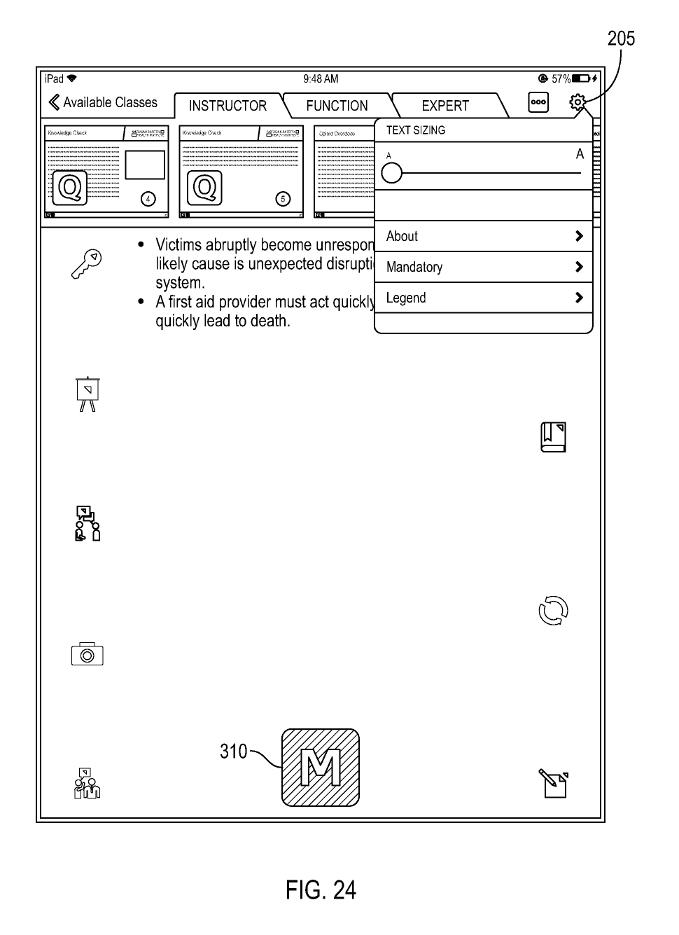

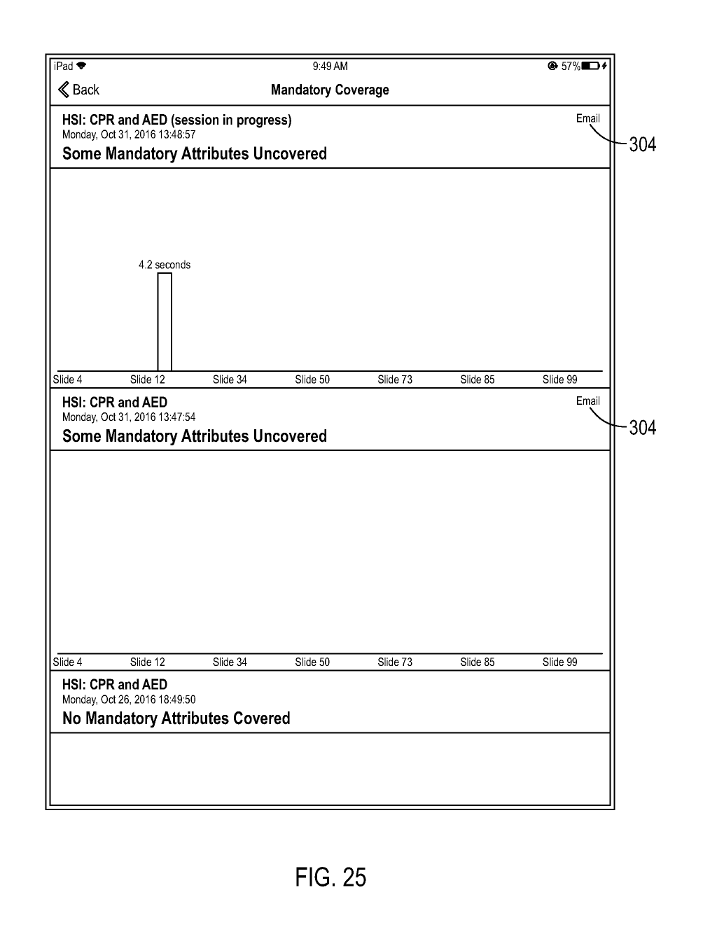

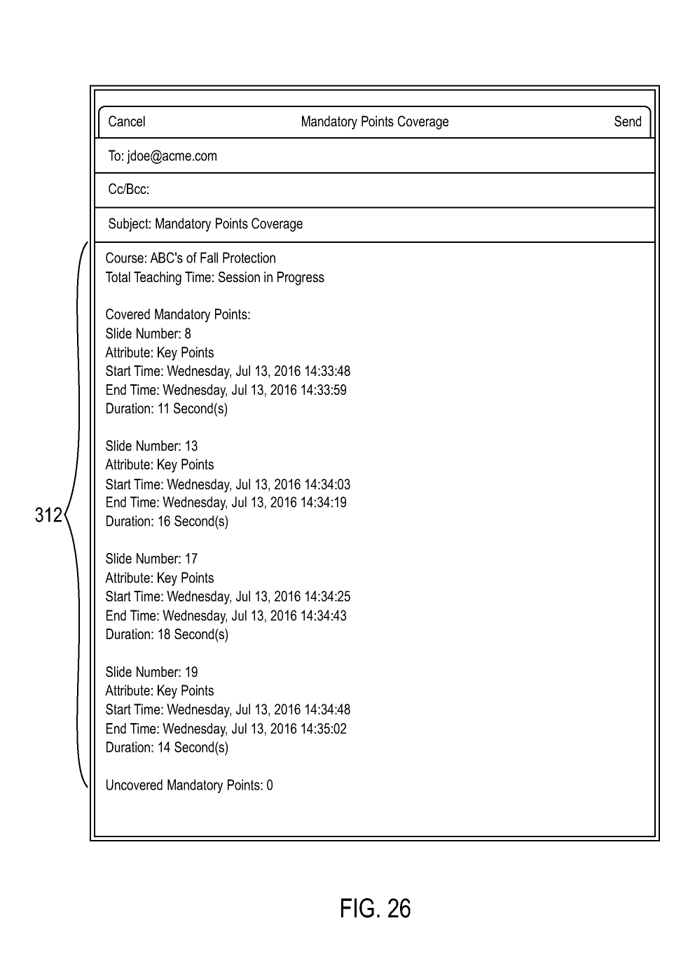

In FIG. 24, the instructor may review a summary of completed mandatory points by selection through the menu 205. The summary, illustrated at FIG. 25, includes a graph showing the time spent on each slide containing a mandatory point. The instructor may select the “email” icon 304 to send a report of the summary of the mandatory points. Referring to FIG. 26, the application drafts a text summary 312 of the mandatory point covered, including course title, slide number on which the mandatory point appeared, the attribute marked as a mandatory point, start time, end time and duration.

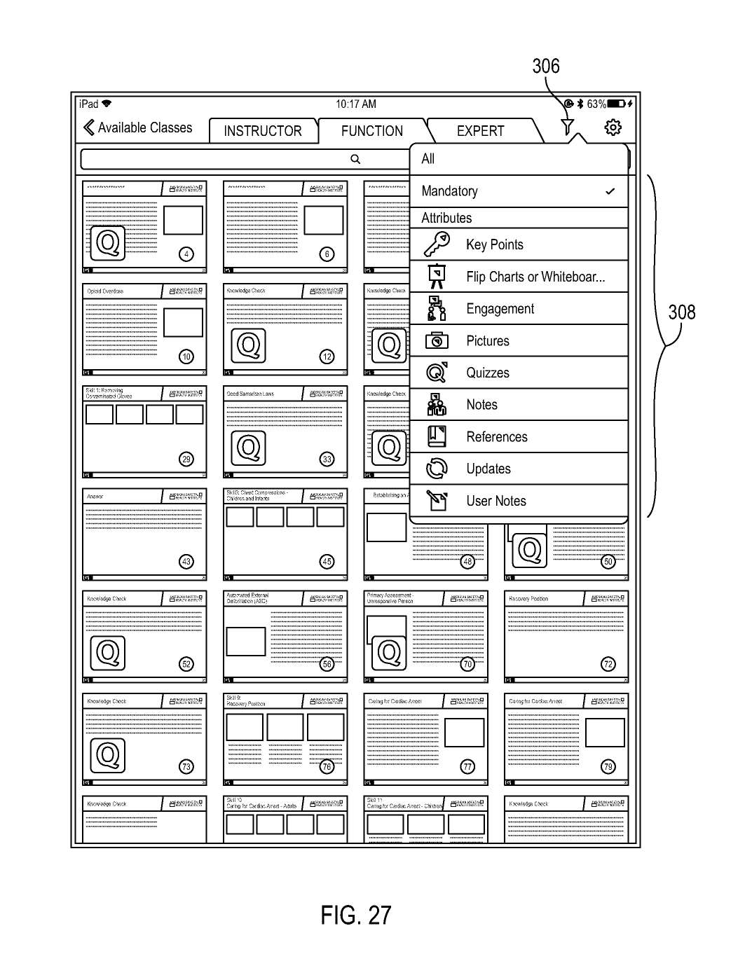

Referring to FIG. 27, an exemplary screenshot of viewing slides with mandatory points while in function mode of the client application is shown. The instructor may sort the slides by mandatory points using the filter icon 306, which provides a menu of filters 308 to sort by.

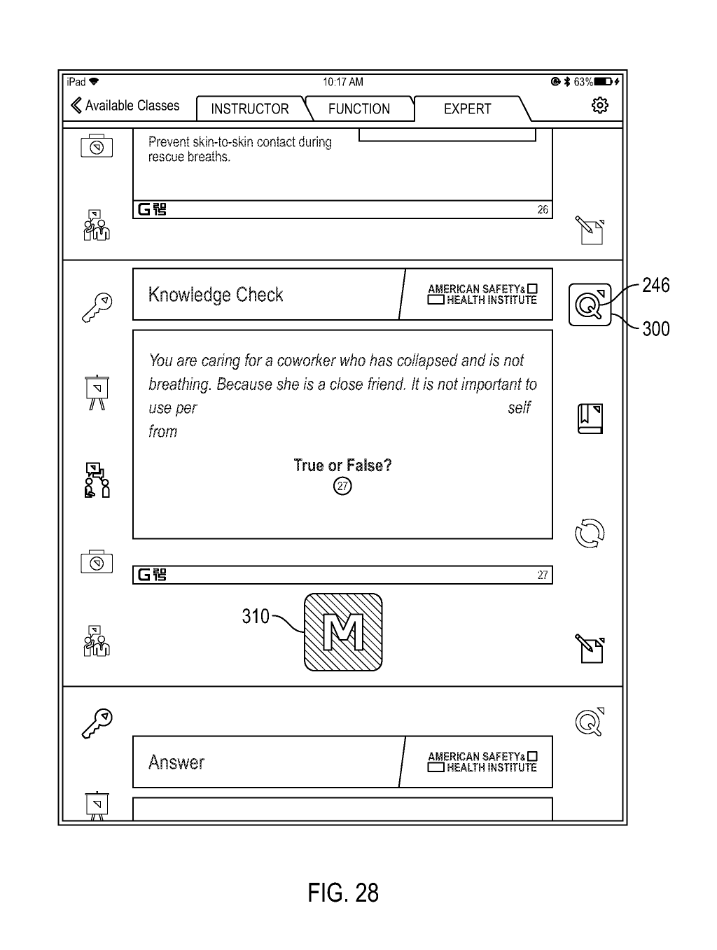

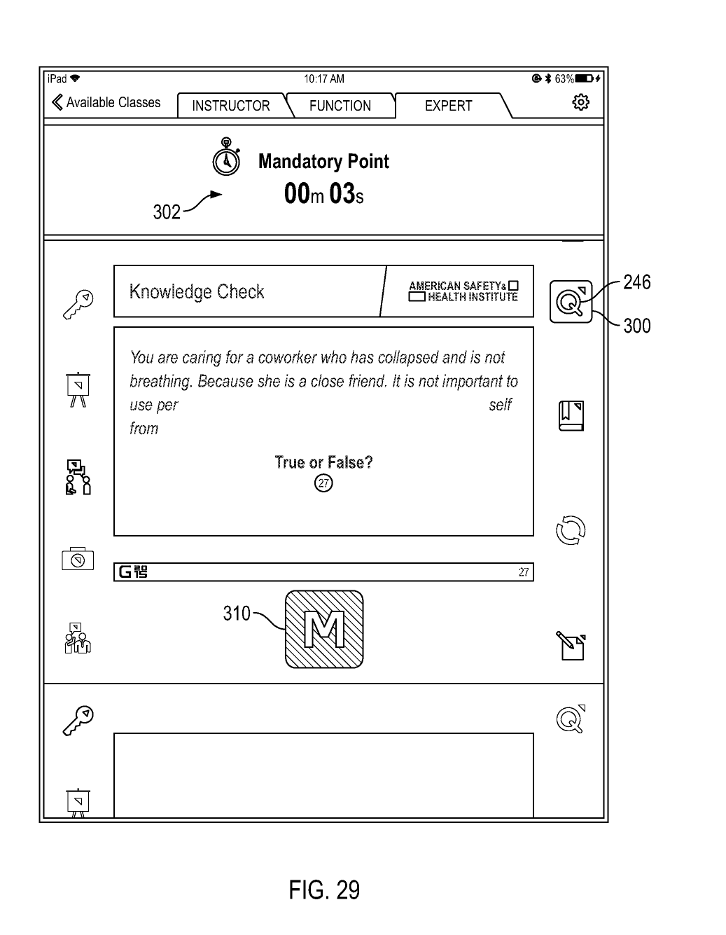

Referring to FIGS. 28-29, exemplary screenshots of a mandatory points feature of an application for a training management system while in expert mode are shown, which is similar to the mandatory points in instructor mode. In FIG. 28, the slide quiz icon may be indicated as including a mandatory point with a red box 300. A red, animated M 310 may also be indicated in the display area. In FIG. 29, like instructor mode, selecting the M starts a stopwatch time and disables navigation from the slide, although selecting the action of other icons is still enabled. Selecting the M icon again turns the M icon green and stops the stopwatch timer. Navigation is re-enabled between other slides. The indication around the quiz icon may also be turned green too.

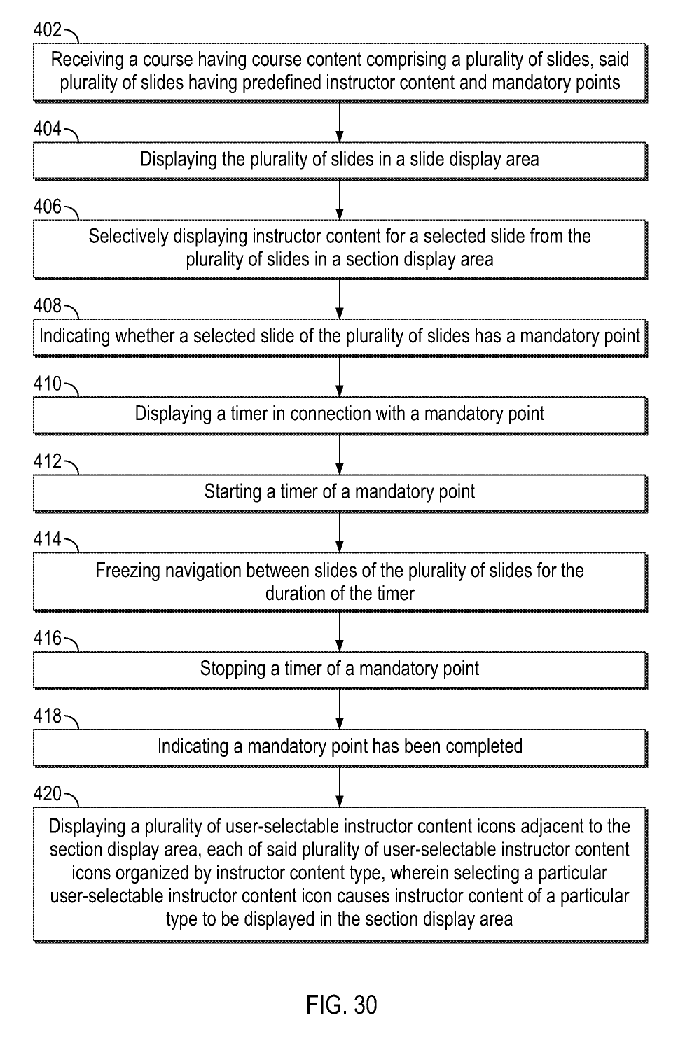

Referring to FIG. 30, an exemplary computer-implemented method or process 400 of providing a presentation of the training management system described herein.

Process 400 may include receiving a course having course content comprising a plurality of slides, said plurality of slides having predefined instructor content and mandatory points (block 402). For instance, a user may select a synchronization icon 209 or synchronize all icon 211 to receive course 202 on an available courses screen (FIG. 3).

Process 400 may include displaying a plurality of slides in a slide display area (block 404). For instance, client application 200 may include a slide display area 207 to display slides 206 of a presentation as illustrated in FIG. 5-15, for example.

Process 400 may include selectively displaying instructor content for a selected slide from the plurality of slides in a section display area (block 406). For instance, selecting a “key points” icon 224, may cause key points 225 of a slide 206 to be displayed in a display area 208 of a client application 200.

Process 400 may include indicating whether a selected slide of the plurality of slides has a mandatory point (block 408). For instance, a box 300 may be visually placed around an icon, such as a “key points” icon 224. Additionally, a graphic, such as an animated letter M 310 may be displayed in the display area, that alerts the instructor of a mandatory point to be covered in the presentation.

Process 400 may include displaying a timer in connection with a mandatory point (block 410). For instance, a timer 302 may be displayed in a slide display area 207.

Process 400 may include starting a timer of a mandatory point (block 412). For instance, a timer 302 may be displayed in a slide display area 207 that counts down or up a predetermined (e.g. minimum) amount of time that instructor must spend reviewing the mandatory point during the presentation. Alternatively, the timer may be open-ended, tracking the amount of total time spent on the mandatory point by the instructor.

Process 400 may include freezing navigation between slides of the plurality of slides for the duration of the timer (block 414). For instance, a timer 302 may be displayed in a slide display area 207, obscuring or hiding the slide navigation features of the slide display area 207. The timer 302 may disappear, revealing the slide display area 207, and thus allowing navigation, at the end of the predetermined time.

Process 400 may include stopping a timer of a mandatory point (block 416). For instance, a user may activate the timer 302 again to pause the timer 302, or once the predetermined time has lapsed, stop the timer 302 automatically.

Process 400 may include indicating a mandatory point has been completed (block 418). For instance, a box 300 placed around an icon may be changed color, such as from red to green. Also, or alternatively, a graphic such as an animated letter M 310 may be changed color and the animation ceased.

Process 400 may include displaying a plurality of user-selectable instructor content icons adjacent to the section display area, where the icons (block 420). Further, process 400 may include displaying content of a particular type in a display area in response to selection of a user-selectable instructor content icon. For instance, left icon area 218 and a right icon are 220 may be provided with icons 224, 226, 232, 234, 240, 246, 250, 254, 256, that organize instructor content by content type.

Therefore, it can be seen that the present training management system solves the problems of the prior art by providing a system that uses dynamic engagement techniques to gain student attention and provide consistent delivery of course instruction through a combination of guided prompts and mandatory points to the course instructor.

It would be appreciated by those skilled in the art that various changes and modifications can be made to the illustrated embodiments without departing from the spirit of the present invention. All such modifications and changes are intended to be within the scope of the present invention.

What is claimed is:

1. A computer-implemented method for providing a presentation, comprising:
receiving a course having course content comprising a plurality of slides, said plurality of slides having predefined instructor content and mandatory points;
displaying the plurality of slides in a slide display area;
selectively displaying instructor content for a selected slide from the plurality of slides in a section display area;
indicating whether a selected slide of the plurality of slides has a mandatory point.

2. The method of claim 1, further comprising displaying a timer in connection with a mandatory point.

3. The method of claim 2, further comprising starting a timer of a mandatory point.

4. The method of claim 3, further comprising freezing navigation between slides of the plurality of slides for the duration of the timer.

5. The method of claim 3, wherein the timer counts down or up for a predetermined duration.

6. The method of claim 2, further comprising stopping a timer of a mandatory point.

7. The method of claim 1, further comprising indicating a mandatory point has been completed.

8. The method of claim 1, further comprising displaying a plurality of user-selectable instructor content icons adjacent to the section display area, each of said plurality of user-selectable instructor content icons organized by instructor content type, wherein selecting a particular user-selectable instructor content icon causes instructor content of a particular type to be displayed in the section display area.

9. The method of claim 1, wherein the instructor content comprises key talking points, flip board/white board information, engagement directives, images, mentor notes, and quiz questions for a selected slide from the plurality of slides.

10. The method of claim 8, wherein the instructor content type comprises key talking points, flip board/white board information, engagement directives, images, mentor notes, and quiz questions.

11. The method of claim 1, wherein the indication of a slide as a mandatory point comprises displaying a box around one or the plurality of user-selectable the instructor content icons.

12. The method of claim 11, wherein the indication of a slide as a mandatory point comprises displaying a mandatory point icon in the section display area.

13. The method of claim 12, wherein the mandatory point icon is animated.

14. A computer device for providing a presentation, comprising:
one or more processors;
one or more computer-readable storage media storing instructions executable by the one or more processors to perform acts comprising:
receiving a course having course content comprising a plurality of slides, said plurality of slides having predefined instructor content and mandatory points;
displaying the plurality of slides in a slide display area;
selectively displaying instructor content for a selected slide from the plurality of slides in a section display area;
indicating whether a selected slide of the plurality of slides has a mandatory point.

15. The computing device of claim 14, the acts further comprising:
displaying a timer in connection with a mandatory point.

16. The computing device of claim 15, the acts further comprising:
starting a timer of a mandatory point.

17. The computing device of claim 16, the acts further comprising:
freezing navigation between slides of the plurality of slides for the duration of the timer.

18. The computing device of claim 16, wherein the timer counts down a for a predetermined duration.

19. The computing device of claim 15, the acts further comprising:
stopping a timer of a mandatory point.

20. The computing device of claim 14, the act further comprising:
indicating a mandatory point has been completed.
